(19) United States
(12) Patent Application Publication
(10) Pub. No.: US 2010/0047535 A1
(43) Pub. Date: Feb. 25, 2010

(54) CORE LAYER STRUCTURE HAVING VOLTAGE SWITCHABLE DIELECTRIC MATERIAL

(76) Inventors: Lex Kosowsky, San Jose, CA (US); Robert Fleming, San Jose, CA (US)

Correspondence Address: MAHAMEDI PARADICE KREISMAN LLP, 550 Winchester Boulevard, Suite 605, SAN JOSE, CA, 95128, US

(21) Appl. No.: 12/541,963

(22) Filed: Aug. 16, 2009

Related U.S. Application Data
(60) Provisional application No. 61/091,288, filed on Aug. 22, 2008.

(51) Int. Cl. B32B 3/10; B32B 9/04; B05D 5/12; C23C 28/00

(52) U.S. Cl. 428/195.1; 428/411.1; 427/58; 205/183; 205/188

(57) ABSTRACT

A core layer structure is provided for substrate and packed devices. The core layer structure includes a first layer, a second layer combined with the first layer. A layer of voltage switchable dielectric (VSD) material provided in between the first layer and second layer

### RELATED APPLICATIONS

This Application claims benefit of priority to Provisional U.S. Patent Application No. 61/091,288 filed Aug. 22, 2008; the aforementioned priority application being hereby incorporated by reference in its entirety.

### BACKGROUND

Voltage switchable dielectric (VSD) materials are materials that are insulative at low voltages and conductive at higher voltages. These materials are typically composites comprising of conductive, semiconductive, and insulative particles in an insulative polymer matrix. These materials are used for transient protection of electronic devices, most notably electrostatic discharge protection (ESD) and electrical overstress (EOS). Generally, VSD material behaves as a dielectric, unless a characteristic voltage or voltage range is applied, in which case it behaves as a conductor. Various kinds of VSD material exist. Examples of voltage switchable dielectric materials are provided in references such as U.S. Pat. No. 4,977,357, U.S. Pat. No. 5,068,634, U.S. Pat. No. 5,099,380, U.S. Pat. No. 5,142,263, U.S. Pat. No. 5,189,387, U.S. Pat. No. 5,248,517, U.S. Pat. No. 5,807,509, WO 96/02924, and WO 97/26665, all of which are incorporated by reference herein.

VSD materials may be formed in using various processes. One conventional technique provides that a layer of polymer is filled with high levels of metal particles to very near the percolation threshold, typically more than 25% by volume. Semiconductor and/or insulator materials is then added to the mixture.

Another conventional technique provides for forming VSD material by mixing doped metal oxide powders, then sintering the powders to make particles with grain boundaries, and then adding the particles to a polymer matrix to above the percolation threshold.

Other techniques for forming VSD material are described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES.

### BRIEF DESCRIPTION OF THE DRAWINGS

FIG. 1 is an illustrative (not to scale) sectional view of a layer or thickness of voltage switchable dielectric (VSD) material, depicting the constituents of VSD material in accordance with various embodiments.

FIG. 2A is a simplified and representative cross-sectional view of a core layer structure for use in forming substrate (e.g. printed circuit board (PCB)) and packaged devices, according to one or more embodiment.

FIG. 2B illustrates the core layer structure of FIG. 2A, further processed and layered as part of a build process to form a printed circuit board or substrate device.

FIG. 2C depicts the use of additional layers of material on the core layer structure shown with FIG. 2B.

FIG. 2D illustrates the use of resistive material in the core layer structure, under an embodiment.

FIG. 2E illustrates a core layer structure that includes an embedded resistive layer or element to electrically isolate conductive elements, under an embodiment.

FIG. 2F is a representative circuit diagram of how embedded resistive material can serve to isolate and further protect select devices in combination with layers of VSD material, under an embodiment.

FIG. 3 is a representative cross-sectional view of a core layer structure, under another embodiment.

FIG. 4A through FIG. 4C illustrate a process for forming a core layer structure in accordance with one or more embodiments described.

FIG. 5A through FIG. 5C illustrate a process for forming a core layer structure such as described with various embodiments herein.

FIG. 6A and FIG. 6B illustrate another embodiment that uses a seed layer to form the one of the conductive layers of core layers such as described herein.

### DETAILED DESCRIPTION

Embodiments described herein provide for a core layer structure, such as used to create a printed circuit board or packaged substrate device, having an integrated layer of voltage switchable dielectric (VSD) material. Among other benefits, a core layer structure with an integrated layer of VSD material has inherent capabilities for handling ESD or EOS events. Such core layer structures may serve as building blocks from which printed circuit board or substrate devices are created, and the inclusion of VSD material in the core layer structure enables such devices to more readily provide grounding traces and elements to protect sensitive electrical components of the device ESD, EOS or other harmful electrical events.

Embodiments further recognize that the use of an integrated layer of VSD material in a core layer structure can be configured to switch vertically (or in the vertical plane) in order to handle electrical events such as those that arise from ESD or EOS. More specifically, the integrated VSD layer can form an ESD protection circuit in the vertical plane of the substrate (e.g. across the substrate's thickness) instead of in the substrate's horizontal plane. Embodiments recognize that such vertical ESD protective circuits may be implemented using VSD material deposited as a layer of thickness in a foil or conductive core of substrate devices and packages. The use of VSD material in the thickness of the conductive layer allows for smaller more controllable gap sizes for ESD circuit formation on a conductive surface. Embodiments described herein provide various techniques and enhancements for implementing a layer of VSD material within a thickness of a conductive layer or surface.

A core layer structure is provided for substrate and packed devices. The core layer structure includes a first layer, a second layer combined with the first layer. A layer of voltage switchable dielectric (VSD) material provided in between the first layer and second layer.

According to some embodiments, at least one of the first layer or second layer is comprised of conductive material and is in direct contact with the VSD material. In some embodiments, both of the first layer or second layer are comprised of conductive material and are in contact with the VSD material. As an alternative or addition, layers of insulative or resistive material may be included in the core layer structure.

Still further, some embodiments provide a core layer structure that uses resistive material in combination with VSD material to electrically isolate an discrete element that is provided on a corresponding conductive layer. In an embodiment, a conductive surface layer is patterned to provide a plurality of discrete elements. A layer of VSD material underlies the surface layer, and a conductive element electrically connects the layer of VSD material to ground. The surface layer includes resistive material that occupies a space between two or more of the discrete elements.

### Voltage Switchable Dielectric (Vsd) Material

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. In many applications, the characteristic voltage of VSD material ranges in values that exceed the operational voltage levels of the circuit or device several times over. Such voltage levels may be of the order of transient conditions, such as produced by electrostatic discharge, although embodiments may include use of planned electrical events. Furthermore, one or more embodiments provide that in the absence of the voltage exceeding the characteristic voltage, the material behaves similar to the binder (i.e. it is non-conductive or dielectric).

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

According to embodiments described herein, the constituents of VSD material may be uniformly mixed into a binder or polymer matrix. In one embodiment, the mixture is dispersed at nanoscale, meaning the particles that comprise the conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, thin-film electronics, Light Emitting Diodes (LEDs), radio-frequency (RF) components, and display devices.

Some compositions of Vsd materials work by loading conductive and/or semiconductive materials into a polymer binder in an amount that is just below percolation. Percolation may correspond to a statistically defined threshold by which there is a continuous conduction path when a relatively low voltage is applied. Other materials insulative or semiconductive materials may be added to better control the percolation threshold. Still further, some embodiments may compose VSD material formed from varistor particles dispersed in a polymer resin.

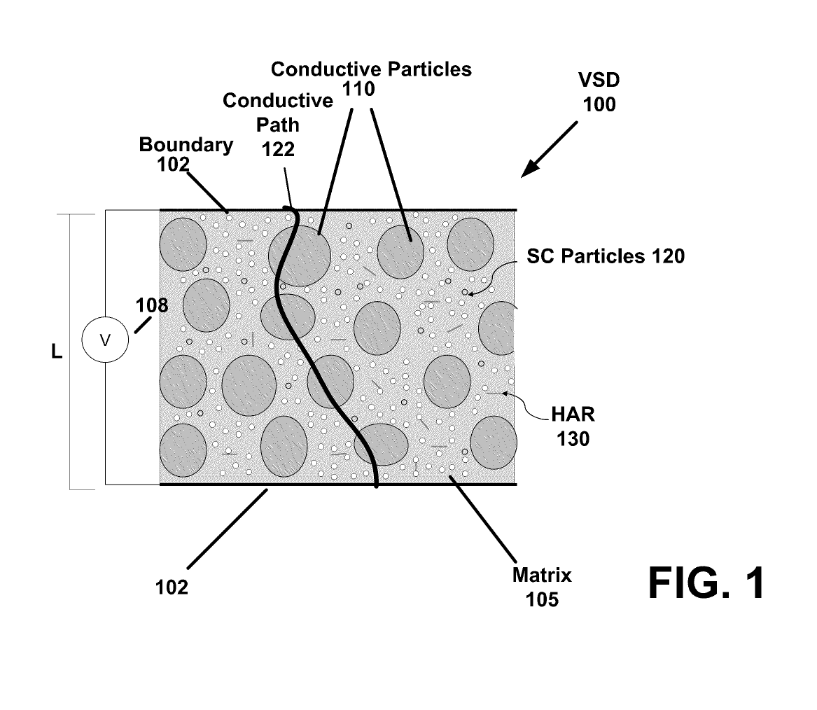

FIG. 1 is an illustrative (not to scale) sectional view of a layer or thickness of VSD material, depicting the constituents of VSD material in accordance with various embodiments. As depicted, VSD material 100 includes matrix binder 105 and various types of particle constituents, dispersed in the binder in various concentrations. The particle constituents of the VSD material may include metal particles 110, semiconductor particles 120, and/or high-aspect ratio (HAR) particles 130. It should be noted that the type of particle constituent that are included in the VSD composition may vary, depending on the desired electrical and physical characteristics of the VSD material. For example, some VSD compositions may include metal particles 110, but not semiconductive particles 120 and/or HAR particles 130. Still further, other embodiments may omit use of conductive particles 110.

Examples for matrix binder 105 include polyethylenes, silicones, acrylates, polymides, polyurethanes, epoxies, polyamides, polycarbonates, polysulfones, polyketones, and copolymers, and/or blends thereof.

Examples of conductive materials 110 include metals such as copper, aluminum, nickel, silver, gold, titanium, stainless steel, chrome, other metal alloys, or conductive ceramics like titanium diboride. Examples of semiconductive material 120 include both organic and inorganic semiconductors. Some inorganic semiconductors include, silicon carbide, boron nitride, aluminum nitride, nickel oxide, zinc oxide, zinc sulfide, bismuth oxide, titanium dioxide, cerium oxide, bismuth oxide, tin oxide, indium tin oxide, antimony tin oxide, and iron oxide. The specific formulation and composition may be selected for mechanical and electrical properties that best suit the particular application of the VSD material. The HAR particles 130 may be organic (e.g. carbon nanotubes, graphene) or inorganic (e.g. nano-wires or nanorods), and may be dispersed between the other particles at various concentrations. More specific examples of HAR particles 130 may correspond to conductive or semi-conductive inorganic particles, such as provided by nanowires or certain types of nanorods. Material for such particles include copper, nickel, gold, silver, cobalt, zinc oxide, tin oxide, silicon carbide, gallium arsenide, aluminum oxide, aluminum nitride, titanium dioxide, antimony, boron nitride, tin oxide, indium tin oxide, indium zinc oxide, bismuth oxide, cerium oxide, and antimony zinc oxide.

The dispersion of the various classes of particles in the matrix 105 may be such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L. In the conductive state, the matrix composite (comprising matrix binder 105 and particles constituents) conducts charge (as depicted by conductive path 122) between the conductive particles 110, from one boundary of VSD material to the other. One or more embodiments provide that VSD material has a characteristic voltage level that exceeds that of an operating circuit. As mentioned, other characteristic field measurements may be used.

Specific compositions and techniques by which organic and/or HAR particles are incorporated into the composition of VSD material is described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES; both of the aforementioned patent applications are incorporated by reference in their respective entirety by this application.

In an embodiment in which VSD material is formed from varistor particles dispersed in a polymer resin, metal oxide varistors may be formed using Bi, Cr, Co, Mn, W, and Sb. The composition may be formed using doped ZnO or TiO2 powder that is sintered at 800° C. to 1300° C., although other temperature ranges may be used. The sintering results in electrical particles having electrical conductivity which changes as a nonlinear function against applied electrical field.

### Core Structures

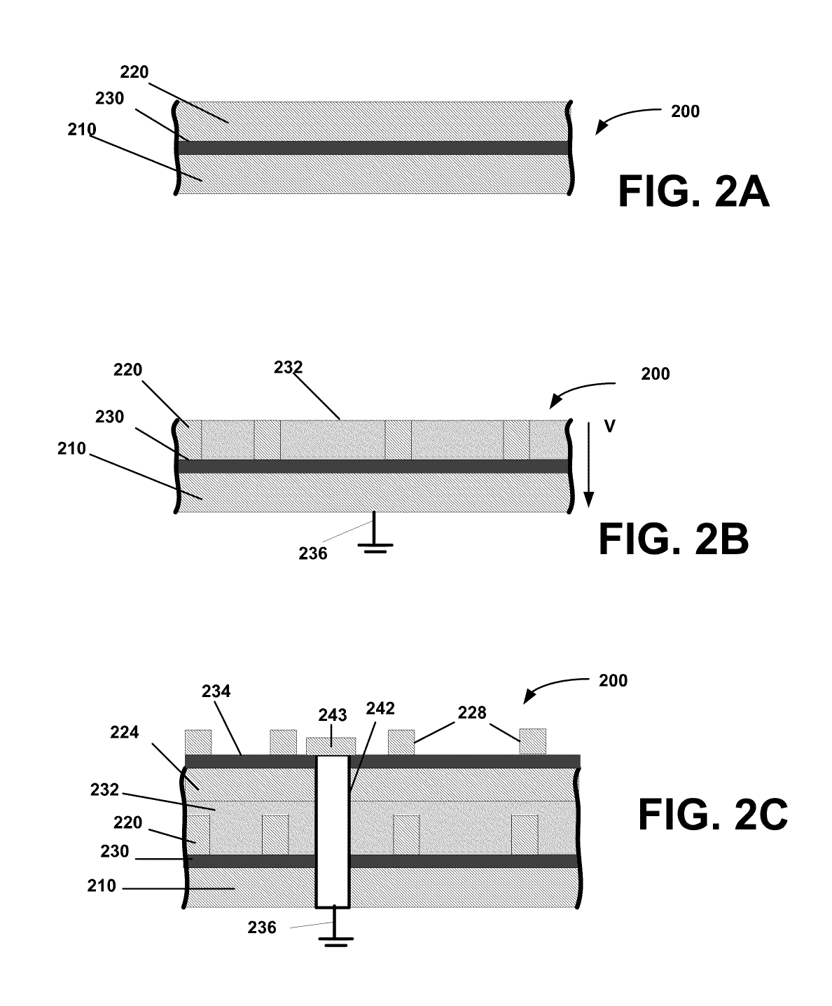

FIG. 2A is a simplified and representative cross-sectional view of a core layer structure for use in forming substrate (e.g. printed circuit board (PCB)) and packaged devices, according to one or more embodiment. The core layer structure may correspond to a conductive foil or plate of material having a layer of VSD material inserted therein. A core layer structure such as described herein may include layers of conductive material, insulative material and/or resistive material. In some embodiments, a sectional portion of a thickness of a core layer structure includes metal/conductive layers that sandwich a layer or VSD material. Other embodiments may provide for the core layer structure to sandwich VSD material between a conductive layer and a resistive layer, or between a conductive layer and an insulative layer (such as prepreg). Any of the core layer structures may be further processed, such as by patterning (e.g. etching) to remove material from the layer and enable the integration of another kind of material.

FIG. 1 illustrates examples of the different types or formulations of VSD material that may be used in a core layer structure, such as described with the various embodiments provided below, including with FIG. 2A through FIG. 2E.

With reference to an embodiment of FIG. 2A, conductive foil 200 (or core layer structure) includes a first layer 210, second layer 220, and VSD layer 230 provided directly in between. At least one of first or second layer 210, 220 is formed from conductive material, such as copper, silver, gold or other metal. The VSD material may have a formulation in accordance with those described with FIG. 1. In an embodiment, a layer of VSD material 230 is deposited (or sandwiched) between two layers of conductive material 110, 120. For example, the VSD material 230 may be sandwiched between two layers of copper.

The conductive foil 200 may be subjected to different processes to form circuitry, and may be packaged or otherwise made integral to devices such as printed circuit board (PCB) and packaged devices. A configuration such as shown enables ESD protection circuits to be effective in the vertical plane of the thickness.

Because of the inherent properties of the VSD material, the VSD material is insulative, unless ESD or EOS conditions exist, in which case the VSD layer is switched into a conductive state. Specifically, embodiments provide that the VSD material may switch from an insulator to a conductor in presence of voltage or fields in exceed of a threshold level (e.g. clamp voltage). This property of VSD material enables the VSD material to provide an integrated protective layer for substrate and packaged devices that integrate the conductive foil (or core layer structure), as described with FIG. 2A.

FIG. 2B illustrates a core layer structure such as described with FIG. 2A, further processed and layered as part of a build process to form a printed circuit board or substrate device. In FIG. 2B, the second conductive layer 220 is patterned, then optionally filled by one or more other layers of material. In the example shown by FIG. 2B, the second conductive layer 220 is patterned and filled with a layer of insulative material 232 (e.g. such as prepreg). Insulative material 232 enables electrical elements to be formed that are isolated. As an alternative or addition, resistive material may fill some or all of the gaps. Still further, some of the gaps formed in patterning the second conductive layer 220 may remain unfilled, particularly when the second conductive layer 220 is a surface layer. As depicted by an embodiment of FIG. 2B, first conductive layer 210 may be routed to ground 236. If an electrical event occurs, the layer of VSD material 230 may ‘switch’ (into the conductive state) and carry the resulting current to ground 236. As mentioned, the orientation of the VSD layer 230 in switching to ground is along the vertical plane (depicted by V).

FIG. 2C depicts the use of additional layers of material on a core layer structure. In the example shown, an additional conductive layer 224 is provided on the insulative layer 232. Optionally, additional layers of VSD material 234 are included, as well as another electrical layer 228. A via 242 (having surface contacts 243) may electrically interconnect the VSD layers 230, 234 and the conductive layers 210, 224 to ground 236. In the presence of an electrical event at the surface layer, the VSD layer, for example, 234 may switch vertically, using the via 242 to ground the event.

FIG. 2D illustrates the use of resistive material in a core layer structure, under an embodiment. In an embodiment of FIG. 2D, conductive core layer structure 200 includes first conductive layer 210, VSD layer 230, and a second conductive layer 220 having elements, including elements 220A, 20B. A resistive material 252 is overlaid on the VSD material 230, so as to separate adjacent elements of the second conductive layer. The resistive material 252, in combination with VSD material 230, can enable significant electrical events to be grounded while at the same time providing electrical isolation to more sensitive electrical components 220B. For example, in the presence of an electrical event at element 220A, the VSD layer 230 may switch, carrying current vertically. The presence of the resistive material 252 precludes significant current from the event being dispersed laterally to element 220B, as the path to ground 236 offers least resistance.

FIG. 2E illustrates a core layer structure that includes an embedded resistive layer or element to electrically isolate conductive elements, according to another embodiment. In the section shown by FIG. 2E, the first conductive layer 210 is overlaid with insulative material 232. The layer of VSD material 230 is provided over insulative layer 234. The second conductive layer 220 is formed and patterned to provide trace elements. Resistive material (or layer) 252 may be patterned or selectively formed between some or all of the elements formed from the second conductive layer 220. The via 242 (and its surface contact element 243) may electrically interconnect the VSD layer 230 and the conductive layer 210 to ground 236. As mentioned, the resistive material 252 electrically isolates electrical element (220B). In presence of an electrical event, the VSD layer 230 may switch, so as to electrically connect to the via 242. The path of least electrical resistance is vertical, to ground 236 by way of VSD material 230 and via 262. The resistive material thus isolates and protects adjacent electrical elements by adding resistive elements to the path that could otherwise result if the VSD material between the electrical elements 220A and 220B was to laterally switch.

FIG. 2F is a representative circuit diagram of how embedded resistive material can serve to isolate and further protect select devices in combination with layers of VSD material, according to some embodiments. In particular, FIG. 2F is a circuit diagram illustrating how an ESD event (or other electrical occurrence) would be handled on a core layer structure such as shown by embodiments of FIG. 2D or FIG. 2E. The embedded resistor is provided by, for example, resistive material 252 of FIG. 2E, and is positioned to isolate the element to be protected (see 220B of FIG. 2E). The VSD material 230 switches with the event, enabling the event to be directed vertically to ground 236 (FIG. 2E) as result of the vertical path having less resistance than the electrical path leading to element 220B.

Some of the many variations to the core layer structure and configuration described with FIG. 2A through FIG. 2E are described below. With embodiments described below and elsewhere, additional processing steps (such as described with FIG. 2B through FIG. 2E) may be performed to build substrate and circuit board devices from the core layer structures. For example, the core layer structures described with various embodiments below and elsewhere may be processed further by (i) patterning, to form trace elements and isolation elements or regions; (ii) forming vias and micro-vias that pass through the core layer structure to electrically connect (or enable connection using VSD) trace elements on multiple layers, or elements to ground; and/or (iii) multi-layering, to add additional layers of VSD, conductive, resistive or insulative material onto patterned or processed layers.

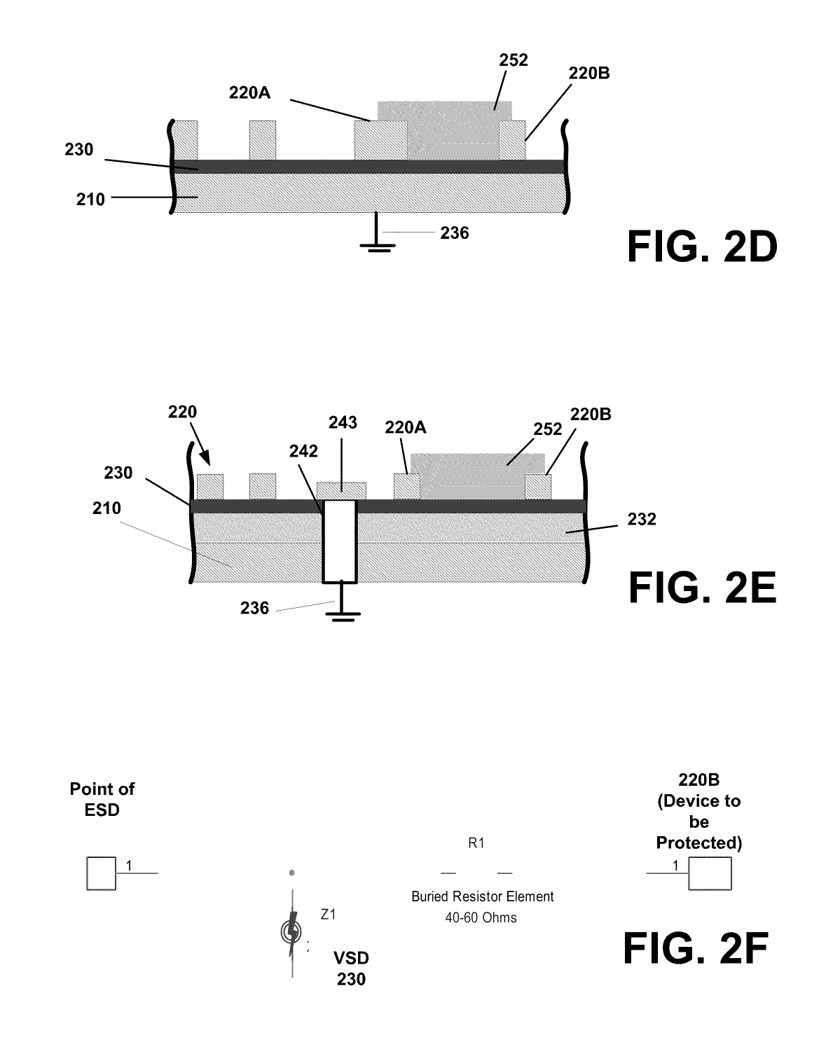

FIG. 3 is a representative cross-sectional view of a core layer structure, under another embodiment. In an embodiment shown, the core layer structure 300 corresponds to a conductive foil or plate of material having a layer of VSD material inserted therein. The core layer structure 300 may be substituted for any of the examples described above or elsewhere.

In more detail, core layer structure 300 utilizes conductive material 310 of a first kind (copper) as a plane that initially receives the layer of VSD material 320. Conductive material of a second kind (e.g. silver) 330 is provided over the VSD material 320 to form a combined structure. The second layer of conductive material 330 is formed, deposited or otherwise provided on the VSD layer 320, so as to form a heterogeneous pair of conductive layers within the foil 300.

Different techniques may exist for providing the layer of VSD material 320 with either the first or second conductive layers 310, 330. For example, one embodiment provides that the VSD layer 320 is pressed between sheets of metal (e.g. two copper) sheets. In another implementation, the VSD material 320 is cured between the two conductive layers 310, 330(or between differing types of conductive layers 112, 202) at the same time.

An embodiment of FIG. 3, which illustrates use of different kinds of conductive material to form a core layer structure, may be applied to other embodiments described herein. For example, core layer structures shown with embodiments of FIG. 2B through FIG. 2E may incorporate different kinds of conductive material on separate layers of the core layer structures described.

### Core Layer Structure Formation

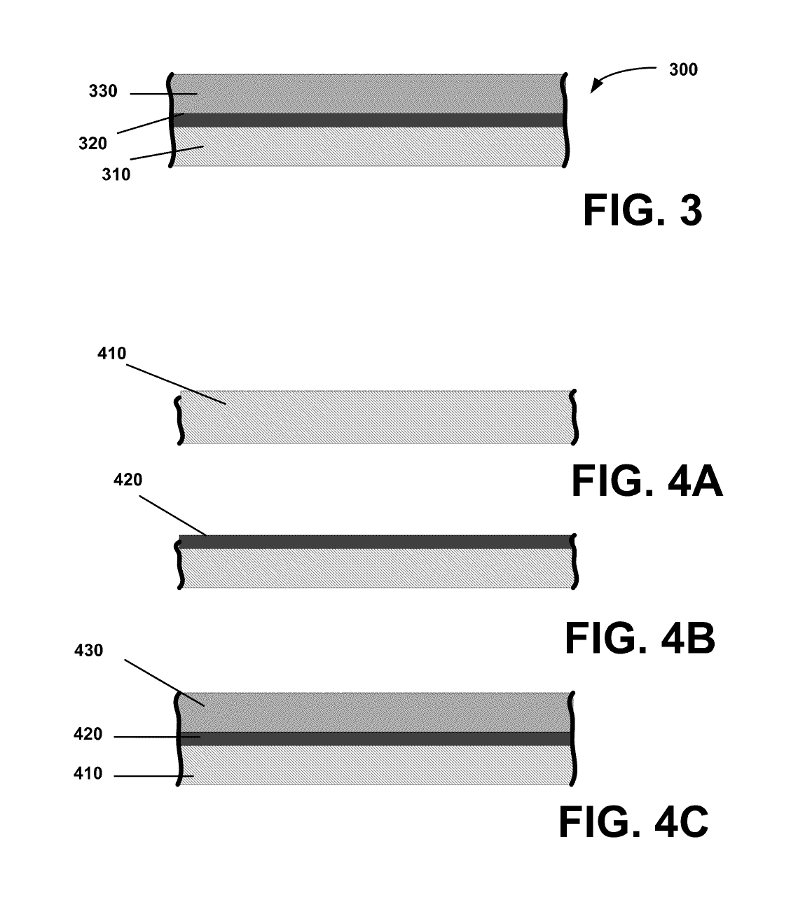

Still further, an embodiment of FIG. 4A through FIG. 4C illustrates a process for forming a core layer structure in accordance with one or more embodiments described. In FIG. 4A, a first layer 410 of the core layer structure is formed. The first layer 410 may be formed from conductive material, such as copper or silver.

In FIG. 4B, a second layer 420 comprising VSD material is formed over the first layer 410. In the example provided, the VSD material is formed directly over the first layer 410, so as to be in contact with the first layer. Numerous processes and techniques exist to form the VSD material 420 on the first material. In one implementation, the layer of VSD material 420 is deposited on the first layer 410 in liquid form, then cured on site. In an other implementation, the layer of VSD material 420 is B-staged onto the first layer 410. The layer of VSD material 420 on the first conductive layer 410 provides an intermediate stage in the formation of the core.

FIG. 4C illustrates that subsequent to the intermediate stage in which the first and second layers 410, 420 are combined, a third conductive layer 430 is formed or deposited on the combination of first layer 410 and second layer 420. Numerous processes and techniques exist to form the conductive material of the third layer 430 onto the intermediate structure. As described below, for example, some embodiments provide that the third layer 430 is formed or deposited through processes that include electrolytic, electro-less plating. Accordingly, both the first and third layers 410, 430 may be formed from the same conductive material, with the VSD material sandwiched in between. Still further, the conductive material of the third layer 430 may be coated onto the intermediate structure. For example, the third layer 430 may be comprised of conductive ink that can be coated directly onto the intermediate structure.

Alternatively, one of the first or third layers 410, 430 is formed from non-conductive or resistive material, as provided with one or more embodiments described below. Still further, one of the first or third layers may be formed from conductive material and separated from the VSD material of the second layer 420 by resistive or insulative (e.g. prepreg) material.

### Conductive Layer Formation On Vsd

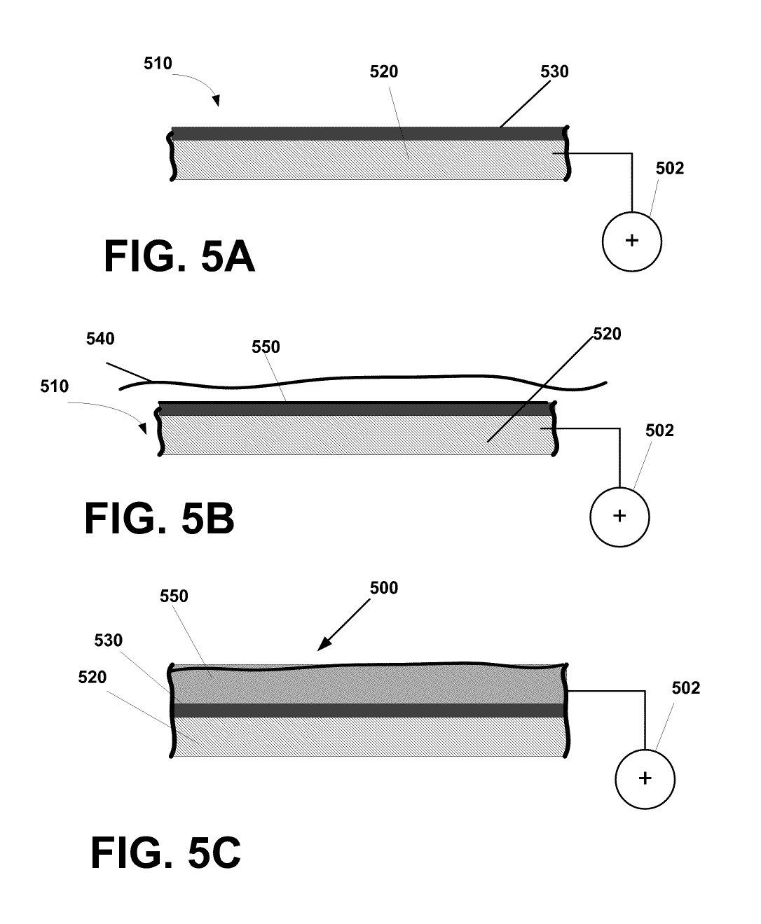

FIG. 5A through FIG. 5C illustrate a process for forming a core layer structure such as described with various embodiments herein. More specifically, FIG. 5A through FIG. 5C show embodiments in which (i) an intermediate structure comprising a first layer of conductive material and VSD material is formed, and (ii) a second conductive layer is formed on the layer of VSD material of the intermediate structure. According to some embodiments, the second conductive layer is formed on the intermediate structure through, for example, an electroplating metal formation process. An embodiment such as described with FIG. 5A through FIG. 5C may be used to develop a core layer structure such as described with various embodiments above, including FIG. 2A through FIG. 2F.

In FIG. 5A, an intermediate structure 510 is formed. The intermediate structure includes a layer of VSD material 530 that is formed over a conductive layer 520. The intermediate structure 510 is coupled to a voltage source 502. Voltage from the voltage source 502 is used to switch the layer of VSD material 530 into a conductive state. Concurrently with the layer of VSD material being switched into the conductive state, the intermediate structure 510 is subjected to an electrolytic solution 540 (FIG. 5B). The second conductive layer 550 starts to form on the VSD material. The composition of the second conductive layer may be selected electrolytic solution 540. In this way, the layer of VSD material 530 is subjected to the solution 540, resulting in the formation of a second conductive layer 550 on top of the layer of VSD material (FIG. 5C). The resulting formation completes a core layer structure 500.

As provided elsewhere, one embodiment provides that the metal in the solution 540 may differ from the metal of the first conductive layer 520. This results in the core layer structure 500 having a first conductive layer 510 that is different than the second conductive layer 550.

As an alternative to electroplating, the layer of VSD material 520 may be switched into the conductive state (using the applied voltage from voltage source 502) and subjected to an electroless process for metal formation.

As another alternative or variation, the same metal formation or deposition process described with the second conductive layer 550 (see FIG. 5C) may be used to form the first conductive layer 520. For example, the first conductive layer 520 may be formed by subjecting VSD material 530 to an electrolytic solution 540 that forms both the first and second conductive layers 520, 550 concurrently.

As alternatives to embodiment described, the electrolytic plating processes described may be implemented as a reel-to-reel process.

### Seed Layer Embodiments

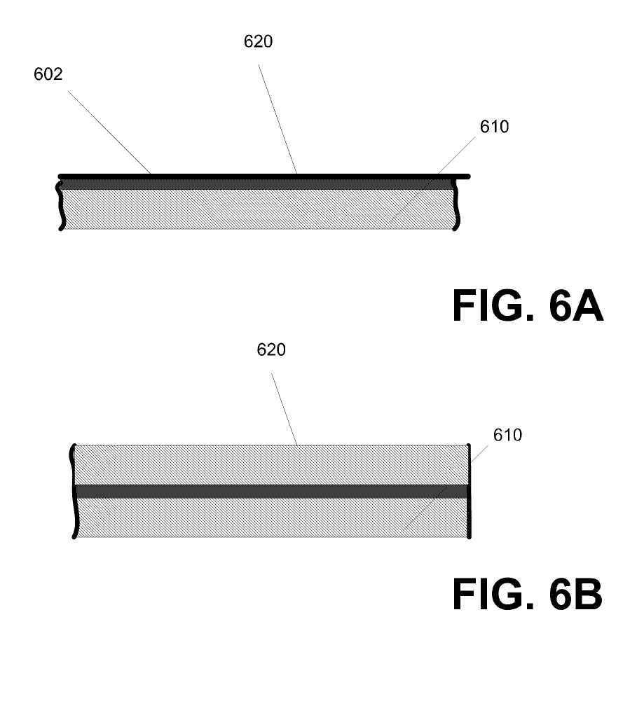

FIG. 6A and FIG. 6B illustrate another embodiment that uses a seed layer to form the one of the conductive layers of core layers such as described herein. As described, a seed layer 602 is used in a process to form one of the conductive layers of a core layer structure 600. With reference to an embodiment of FIG. 6A, seed layer 602 is formed on an intermediate structure 600 comprising a first conductive layer 610 and a layer of VSD material 620. More specifically, the seed layer 602 is formed on the VSD layer 620. The seed layer 602 serves as an alternative to ‘switching’ VSD material to plate a second conductive layer 630 onto the intermediate structure. The seed layer 602 may be provided as a thin layer of material that is deposited or otherwise formed on the layer of VSD material 620, in order to enable subsequent formation of the second conductive layer 620 using, for example, electroless or electrolytical plating. In one embodiment, the seed layer 602 is formed by vacuum deposition after the VSD layer 620 is formed on the first conductive layer 610. For example, the VSD layer 620 may be deposited in liquid form on the first conductive layer 610 and then dried. Subsequently, a vacuum deposition process may be used to form the seed layer 602. Subsequently, the second conductive layer 630 is formed by subjecting the seed layer 602 to an electroplating or electroless process. As an alternative to vacuum deposition, other techniques may be used to form the seed layer 602, such as for example, physical vapor deposition (PVD), chemical vapor deposition (CVD), Sputtering, or atomic layer deposition (ALD). In alternatives or variations, the seed layer 602 may be formed by processes that include (i) trapping the particles of the seed layer 602 in position (i.e. over cured layer of VSD material 620); (ii) depositing the seed layer particles through precipitation.

In some embodiments, the seed layer 602 is conductive, such as metal. Alternatively, the seed layer 602 may be semiconductive for some embodiments. For example, semiconductive particles may be trapped on the cured layer of VSD material 102 to form the seed layer 602.

Still further, the seed layer 602 may be formed from conductive polymer or deposits. The polymer may be either inherently conductive, or loaded with metal particles and/or other conductive elements to render it conductive.

### VARIATIONS

In some embodiments, binderless (i.e. without binder) formulations of varistor particles may comprise one or more of the layers of a core layer structure, as a substitute for VSD material such as described with FIG. 1. In particular, varistor material may be selected that has inherent capability to ‘switch’ into a conductive state in presence of voltage from, for example, an ESD or EOS event.

With regard to some embodiments described (such as with core layer structures of FIG. 2A through FIG. 2E, or a core layer structure formed by a process of FIG. 5A through FIG. 5C), the electrolytic process may be performed to add thickness to one or both of the conductive layers that form the core layer structure. For example, an electrolytic process may be formed to add thickness to the second conductive layer after an initial thickness is formed or provided on the layer of VSD material.

With regard to some embodiments, one or both conductive layers that comprise the core layer structure may be replaced by a semiconductor material. Still further, one layer may be replaced by resistive material.

As still another embodiment, an adhesion permoter may be used in the interface surface of the layers of conductive material.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Therefore, the absence of describing combinations should not preclude the inventor from claiming rights to such combinations.

What is claimed is:

1. A core layer structure for substrate and packed devices, the core layer structure comprising:
a first layer;
a second layer combined with the first layer;
wherein at least one of the first layer or second layer comprises conductive material;
a layer of voltage switchable dielectric (VSD) material provided in between the first layer and second layer.

2. The core layer structure of claim 1, wherein each of the first layer and second layer is formed from a same conductive material.

3. The core layer structure of claim 1, wherein the layer of VSD material is provided to be in contact with the at least one of the first layer or second layer that comprises conductive material.

4. The core layer structure of claim 1, wherein the first layer comprises conductive material, and the second layer comprises insulative material.

5. The core layer structure of claim 1, wherein the first layer comprises conductive material, and the second layer comprises resistive material.

6. The core layer structure of claim 1, wherein each of the first layer and second layer comprises conductive material, wherein the VSD material is provided to be in contact with one of the first layer and second layer, and wherein the core layer structure comprises one or more additional layers comprised of conductive material, insulative material, or resistive material.

7. The core layer structure of claim 1, wherein the VSD material comprises a combination of conductive and/or semi-conductive particles dispersed in a binder.

8. The core layer structure of claim 1, wherein the VSD material comprises varistor particles.

9. The core layer structure of claim 1, wherein the VSD material comprises varistor particles without a binder.

10. A core layer structure for substrate and packed devices, the core layer structure comprising:
a plurality of layers, the plurality of layers comprising:
a first layer comprising conductive material;
a layer of voltage switchable dielectric (VSD) material formed on the first layer;
a second layer formed on the layer of VSD material, the second layer comprising one of conductive material, insulative material, or resistive material.

11. The core layer structure of claim 10, further comprising a third layer formed on the second layer, the third layer comprising one of conductive material, insulative material, or resistive material.

12. The core layer structure of claim 9, wherein at least one of the second layer or third layer is patterned.

13. A method for forming a core layer structure, the method comprising the steps of:
creating an intermediate structure comprising (i) a first layer, and (ii) a layer of voltage switchable dielectric (VSD) material formed on the first layer; and
forming a second layer on the intermediate structure.

14. The method of claim 13, wherein at least one of the first layer or the second layer is comprised of conductive material.

15. The method of claim 13, wherein at least the first layer is comprised of conductive material, and wherein creating the intermediate structure includes B-staging the layer of VSD material onto the first layer.

16. The method of claim 13, wherein creating the intermediate structure includes coating the layer of VSD material onto the first layer.

17. The method of claim 13, wherein forming the second layer includes forming a thickness of conductive material corresponding to the second layer by subjecting the intermediate structure to an electrolytic plating process.

18. The method of claim 17, wherein forming the thickness includes applying sufficient voltage to the intermediate structure to switch the layer of VSD material into a conductive state, wherein the voltage is applied when the intermediate structure is submerged in an electrolytic solution.

19. The method of claim 17, wherein forming a thickness of conductive material includes using a seed layer to form the thickness when subjecting the intermediate structure to the electrolytic plating process.

20. A core layer structure for substrate and packed devices, the core layer structure comprising:
a surface layer comprising conductive material, the conductive material being patterned to provide a plurality of discrete elements;
a layer of voltage switchable dielectric (VSD) material that underlies the surface layer;
a conductive element that electrically connects the layer of VSD material to ground;
wherein the surface layer includes resistive material that occupies a space between two or more of the discrete elements.

21. The core layer structure of claim 20, wherein the conductive element corresponds to a via that extends, by way of a vertical path through a thickness of the core layer structure, from at least the layer of VSD material to ground.

22. The core layer structure of claim 21, further comprising a layer of insulative material that is provided over and/or under the layer of VSD material.
